(19) United States
(12) Patent Application Publication
(10) Pub. No.: US 2025/0271097 A1
(43) Pub. Date: Aug. 28, 2025

(54) SUPPORTING DEVICE

(71) Applicant: SYNCMOLD ENTERPRISE CORP., New Taipei City (TW)

(72) Inventors: Yung-Hsiang Yang, New Taipei City (TW); Kuang-Po Chen, New Taipei City (TW)

(21) Appl. No.: 19/017,868

(22) Filed: Jan. 13, 2025

Related U.S. Application Data
(60) Provisional application No. 63/558,243, filed on Feb. 27, 2024.

(30) Foreign Application Priority Data
Oct. 23, 2024 (TW) 113211511

(51) Int. Cl. F16M 11/04

(52) U.S. Cl. CPC F16M 11/041

(57) ABSTRACT

A supporting device for carrying a display on a work surface is provided and comprises: a support unit disposed on the work surface; and a carrying module pivotally connected to the support unit and accommodated on a back surface of the display, the carrying module including: a main plate member having at least two buckling tongue pieces; a quick-release sliding member having at least two buckling blocks and two through slots; two elastic members misaligned with the through slots; two first positioning members and two second positioning members respectively passing through the through slots and fixed to the main plate member; wherein the quick-release sliding member can be transformed between a first position and a second position relative to the main plate member, so that the buckling tongue pieces and the buckling blocks can be buckled on or detached from the display.

### CROSS-REFERENCE TO RELATED APPLICATIONS

This application claims the benefit of U.S. Provisional Application Ser. No. 63/558,243 filed on Feb. 27, 2024, and the benefit of Taiwan Patent Application Serial No. 113211511 filed on Oct. 23, 2024. The entirety of each Application is incorporated herein by reference.

### BACKGROUND

### 1. Technical Field

The present disclosure relates to a supporting device, and more particularly, to a supporting device with a quick release function.

### 2. Description of Related Art

China Patent No. 204785351U discloses a quick disassembly mechanism for a display. The quick disassembly mechanism includes a main connecting plate, two limiting pins, two compression springs, a plastic sliding plate and a plastic rear cover, wherein the main connecting plate is provided with a sliding groove covering part and strip-shaped accommodation grooves. The sliding groove covering part is formed by punching out at least two local portions on the left and right sides of the main connecting plate to extend short arms, and bending the short arms to the left and right sides to form a wrap shape together. An upper side of the accommodation groove extends a narrow strip downward along its local portion. The plastic sliding plate is located in the sliding groove covering part and is provided with base blocks extending into the accommodation grooves. The limiting pins pass through positioning sliding grooves of the plastic sliding plate and are fixed to the main connecting plate. The compression springs are accommodated in the accommodation grooves, and their two ends abut against the narrow strips and the base blocks.

However, since the limiting pins are fixed to the main connecting plate directly below the accommodation grooves, the base blocks must overlap with the positioning sliding grooves, which in turn limit the travel of the limiting pins in the positioning sliding groove, and the dimension of the plastic sliding plate must be increased. In addition, the plastic sliding plate is disposed on one side of the main connecting plate away from the plastic rear cover, that is, the plastic sliding plate is at least partially exposed from the main connecting plate, so that improper collision may occur during assembly, and a specific gap is also required between the plastic sliding plate and the back shell of the corresponding display. If the gap is too small, the plastic sliding plate may cause friction with the back shell, and if the gap is too large, the plastic sliding plate may be tilted or shake improperly.

### SUMMARY

The present disclosure provides a supporting device for carrying a display on a work surface, the supporting device comprising: a support unit disposed on the work surface; and a carrying module is pivotally connected to the support unit, and removably and matchingly accommodated on a back surface of the display, the carrying module including: a shell member; a main plate member disposed in the shell member and having at least two buckling tongue pieces and two bending pieces, wherein the buckling tongue pieces protrude from the shell member and are able to buckle on the display; a quick-release sliding member disposed between the main plate member and the shell member, and be able to transform between a first position and a second position relative to the main plate member, the quick-release sliding member having at least two buckling blocks, two base portions and two through slots, the base portions corresponding to the bending pieces and spaced apart from the bending pieces, the through slots respectively adjacent to the base portions and the bending pieces; two elastic members, two ends of the elastic member respectively abut against the bending pieces and the base portions, and the elastic members and the through slots misaligned with each other; two first positioning members respectively passing through the through slots and fixed to the main plate member; and two second positioning members respectively passing through the through slots and fixed to the main plate member, and spaced apart from the first positioning members; wherein when the quick-release sliding member is located at the second position, the elastic members are compressed, ends of the through slots respectively abut against the second positioning member, and the buckling blocks retract into the shell member, allowing the carrying module to be mounted in or detached from the display; wherein when the quick-release sliding member is transformed from the second position to the first position, the elastic members rebound, other ends of the through slots respectively abut against the first positioning member, and the buckling blocks protrude from the shell member, allowing the carrying module to be buckled on the display.

In the aforementioned supporting device, the elastic members constantly provide an elastic force, the elastic force tends to maintain the quick-release sliding member at the first position.

In the aforementioned supporting device, the quick-release sliding member further has a body and two wings, the wings respectively extend outward from opposite sides of the body, the buckling blocks extend outward from a bottom of the body and are spaced apart from each other, the base portions are formed on the body and spaced apart from each other and adjacent to the wings, the through slots are respectively formed through the wings.

In the aforementioned supporting device, the main plate member further has a plate body and two penetrating grooves, the buckling tongue pieces extend outward from the plate body, the penetrating grooves are spaced apart from each other and formed through the plate body, the bending pieces extend outward from the plate body and correspond to the penetrating grooves respectively.

In the aforementioned supporting device, the quick-release sliding member further has two protrusions, the protrusions are spaced apart from each other and extend outward from the body and adjacent to the wings, and the protrusions are accommodated in the penetrating grooves respectively.

In the aforementioned supporting device, the elastic members are a compression springs.

In the aforementioned supporting device, the first positioning members and the second positioning members are step screws.

In the aforementioned supporting device, the shell member has a front shell, at least two upper through holes and at least two lower through holes, the display includes a recess, the front shell is matchingly accommodated and flatly attached to the recess, the upper through holes are formed through the front shell for the buckling tongue pieces to pass through, the lower through holes are formed through the front shell and are spaced from the upper through holes for the buckling blocks to pass through.

In the aforementioned supporting device, the shell member further has a rear shell and an accommodation space, the rear shell is assembled with the front shell to surround together and define the accommodation space, the main plate member and the quick-release sliding member are disposed in the accommodation space, the upper through holes and the lower through holes communicate with the accommodation space.

In the aforementioned supporting device, the carrying module further includes an operating member having a base body and an operating body, the base body is fixed to the quick-release sliding member, the operating body extends outward from the base body, the shell member further has an operating opening formed through the rear shell, and the operating body passes through the operating opening.

As can be understood from the above, the supporting device of the present disclosure uses the first positioning members and the second positioning members to limit the stroke of the quick-release sliding member, and the through slots and the elastic members are misaligned with each other, such that the size of the quick-release sliding member can be reduced. In addition, the quick-release sliding member is sandwiched between the main plate member and the rear shell without being exposed, it is not prone to cause improper collision during assembly and does not cause friction with the back shell of the display, and the front shell can be flatly attached to the recess on the back surface of the display, so as to avoid tilting or improper shaking.

### BRIEF DESCRIPTION OF THE DRAWINGS

FIG. 1 is an exploded schematic diagram of a supporting device according to the present disclosure.

FIG. 2 is an overall schematic diagram of a supporting device according to the present disclosure.

FIG. 3 is an exploded schematic diagram of a carrying module in a supporting device according to the present disclosure.

FIG. 4 is a schematic diagram of another perspective of some members of a carrying module in a supporting device according to the present disclosure.

FIG. 5 is a schematic diagram of a carrying module located at a first position in a supporting device according to the present disclosure.

FIG. 6 is a schematic diagram of a carrying module located at a second position in a supporting device according to the present disclosure.

### DETAILED DESCRIPTION

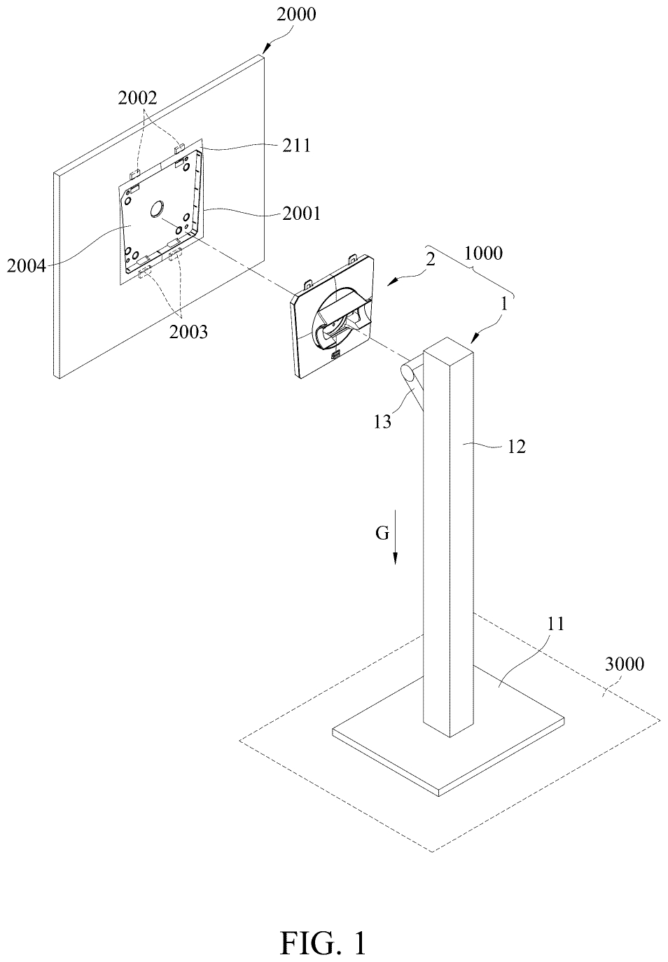

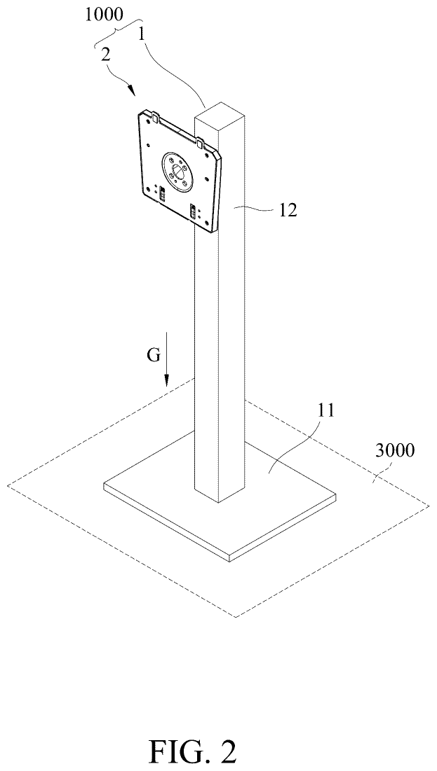

Referring to FIG. 1 and FIG. 2, a supporting device 1000 is used to carry a display 2000 on a work surface 3000 (such as a desktop). The supporting device 1000 comprises a support unit 1 and a carrying module 2, and the display 2000 includes a recess 2001, two upper buckling grooves 2002 and two lower buckling grooves 2003 and a back surface 2004. The upper buckling grooves 2002 correspond to the upper side of the recess 2001, the lower buckling grooves 2003 correspond to the lower side of the recess 2001. The support unit 1 is disposed on the work surface 3000. The carrying module 2 is pivotally connected to the support unit 1 and accommodated in the recess 2001 to carry the display 2000. The structure of each element and the connection relationship between the elements will be described in detail below, and some of the figures are drawn with a gravity direction G.

The support unit 1 includes a chassis 11, a column 12, and a protruding neck 13. The chassis 11 is roughly a rectangular plate to be placed directly on the work surface 3000 stably, but it is not limited to this. The column 12 is roughly a rectangular column to be arranged on the chassis 11 in a manner that it substantially extends along the gravity direction G and slightly inclines toward the work surface 3000. In another embodiment, the column 12 can also be arranged on the chassis 11 in a manner that it extends perpendicularly to the work surface 3000, where there is no limitation. The protruding neck 13 is arranged on the column 12 and extends outward from the column 12.

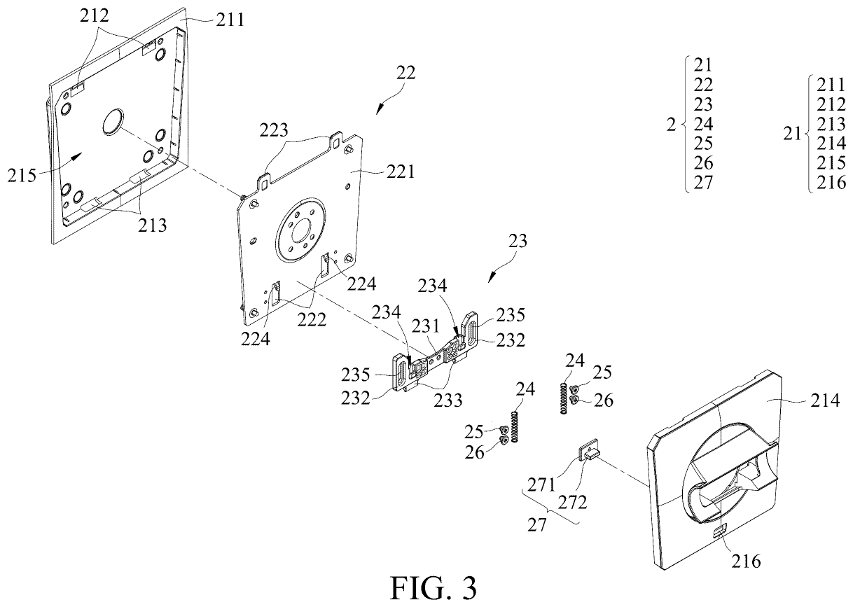

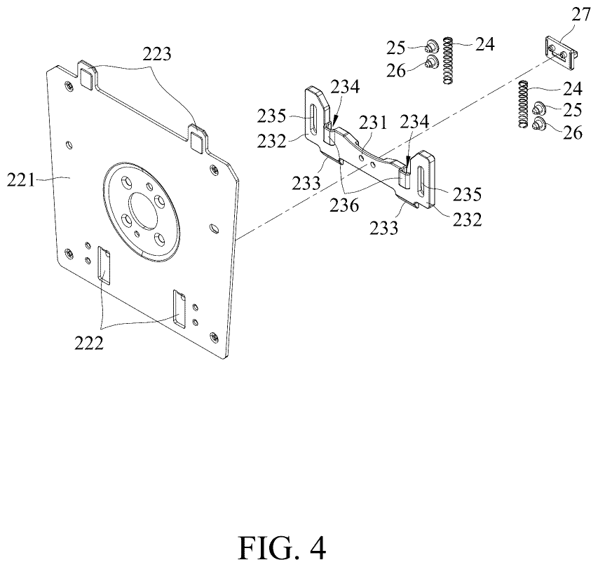

Referring to FIG. 3 and FIG. 4, the carrying module 2 is pivotally connected to the support unit 1, and the carrying module 2 includes a shell member 21, a main plate member 22, a quick-release sliding member 23, two elastic members 24, two first positioning members 25, two second positioning members 26, and an operating member 27.

The shell member 21 has a front shell 211, two upper through holes 212, two lower through holes 213, a rear shell 214, an accommodation space 215, and an operating opening 216. The front shell 211 is roughly in the shape of a rectangular basin, and can be matchingly fixed in the recess 2001 on the back surface 2004 of the display 2000 through screws in advance and be flatly attached to the recess 2001. The upper through holes 212 are spaced apart from each other and formed through the top side of the front shell 211, and can communicate with the upper buckling grooves 2002. The lower through holes 213 are spaced apart from each other and formed through the bottom side of the front shell 211, and can communicate with the lower buckling grooves 2003. The rear shell 214 is roughly in the shape of a rectangular basin and is pivotally connected to the protruding neck 13, and can be assembled with the front shell 211 to surround together and define the accommodation space 215 (i.e., the accommodation space 215 is sandwiched between the front shell 211 and the rear shell 214). The upper through holes 212 and the lower through holes 213 all communicate with the accommodation space 215. The operating opening 216 is formed through the rear shell 214 and adjacent to the lower through holes 213.

The main plate member 22 is accommodated in the accommodation space 215, and the main plate member 22 has a plate body 221, two penetrating grooves 222, two buckling tongue pieces 223, and two bending pieces 224. The plate body 221 is roughly in the shape of an inverted trapezoid. The penetrating grooves 222 are spaced apart from each other and formed through the plate body 221, and are adjacent to the bottom side of the plate body 221, and each has a roughly rectangular cross-section. The buckling tongue pieces 223 extend outward from the top side of the plate body 221 and are spaced apart from each other, and pass through the upper through holes 212 to protrude from the front shell 211. The bending pieces 224 are formed by bending and extending outward from the plate body 221, and are respectively adjacent to the penetrating grooves 222.

The quick-release sliding member 23 is disposed between the main plate member 22 and the rear shell 214, and the quick-release sliding member 23 has a body 231, two wings 232, two buckling blocks 233, two base portions 234, two through slots 235, and two protrusions 236. The body 231 is roughly in the shape of an elongated strip. The wings 232 extend outward from opposite sides of the body 231, so that the body 231 and the wings 232 are roughly U-shaped. The buckling blocks 233 are spaced apart from each other and extend outward from the bottom side of the body 231. The base portions 234 are spaced apart from each other and formed on the body 231. The base portions 234 are respectively adjacent to the wings 232, respectively correspond to the bending pieces 224, and are spaced apart from the bending pieces 224. The through slots 235 are formed respectively through the wings 232. The protrusions 236 are spaced apart from each other and extend outward from the back surface 2004 of the body 231, corresponding to the base portions 234, and are respectively accommodated in the penetrating grooves 222.

One end of each elastic members 24 is sleeved on the bending pieces 224, and the other end is disposed on the base portions 234, so that the elastic members 24 and the through slots 235 are misaligned with each other. The elastic member 24 may constantly provide an elastic force. The first positioning members 25 respectively pass through the through slots 235 and are fixed on the main plate member 22. The second positioning members 26 respectively pass through the through slots 235 and are fixed on the main plate member 22. The second positioning members 26 are spaced apart from the first positioning members 25.

In an embodiment, the elastic member 24 is a compression spring, and the first positioning members 25 and the second positioning members 26 are step screws. However, they are not limited thereto.

The operating member 27 includes a base body 271 and an operating body 272. The base body 271 is fixed on the front side of the body 231 of the quick-release sliding member 23, and is located between the base portions 234. The operating body 272 extends vertically outward from the surface of the base body 271 and passes through the operating opening 216.

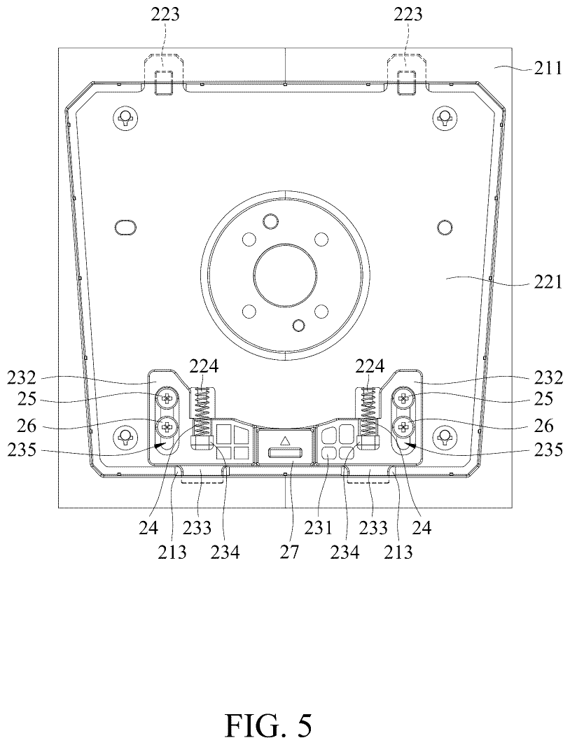

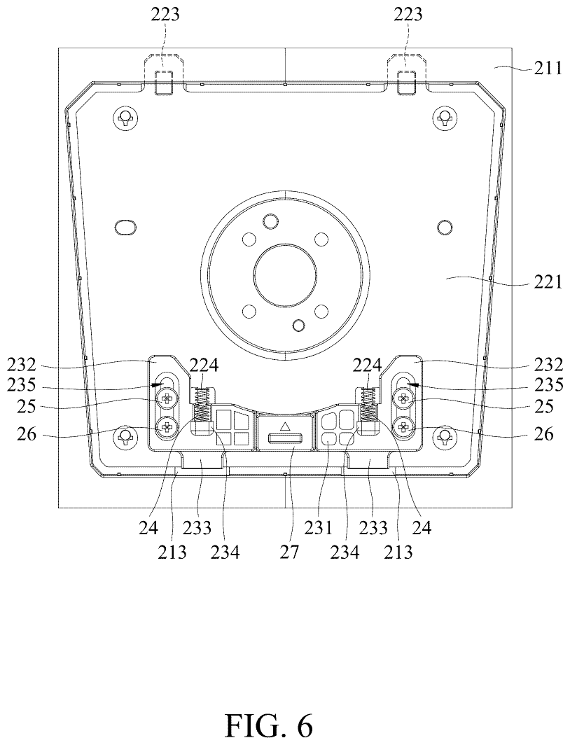

Referring to FIG. 5 and FIG. 6, the quick-release sliding member 23 of the carrying module 2 in the supporting device 1000 of the present disclosure can be transformed between the first position (FIG. 5) and the second position (FIG. 6) relative to the main plate member 22, and the elastic force provided by the elastic members 24 causes the quick-release sliding member 23 to tend to maintain at the first position. As shown in FIG. 5, when the quick-release sliding member 23 is located at the first position, the first positioning members 25 abut against the upper end of the through slots 235, the second positioning members 26 are away from the lower end of the through slots 235, the buckling blocks 233 pass through the lower through holes 213 to protrude from the shell member 21, and the operating body 272 is adjacent to the lower side of the operating opening 216.

Applying an external force to the operating body 272, so that the operating body 272 is away from the lower side of the operating opening 216 and moves toward the upper side of the operating opening 216. Meanwhile, the quick-release sliding member 23 is transformed from the first position to the second position. As shown in FIG. 6, the bending pieces 224 and the base portions 234 jointly compress the elastic members 24, the first positioning members 25 are away from the upper end of the through slots 235, the second positioning members 26 move toward the lower end of the through slots 235 and abut against the lower end of the through slots 235, the buckling blocks 233 retract into the shell member 21. When removing the external force, the elastic members 24 rebounds. At this time, the quick-release sliding member 23 is transformed from the second position to the first position, the buckling blocks 233 pass through the lower through holes 213 to protrude from the shell member 21.

By means of the mechanism that the quick-release sliding member 23 is transformed between the first position and the second position relative to the main plate member 22, the supporting device 1000 of the present disclosure can be quick-releasably (installed or detached) matched to the display 2000. When assembling the supporting device 1000 to the display 2000, the main plate member 22, the quick-release sliding member 23 and the rear shell 214 can be tilted toward the display 2000 so that the buckling tongue pieces 223 firstly buckle into the upper through holes 212 of the front shell 211, which is already fixed in the recess 2001 of the display 2000. Then, an external force is applied to the operating body 272 to cause the quick-release sliding member 23 to transform from the first position to the second position, and the buckling tongue pieces 223 retract into the accommodation space 215, and the main plate member 22, the quick-release sliding member 23, and the rear shell 214 pivot on the buckling tongue pieces 223 until the main plate member 22, the quick-release sliding member 23, and the rear shell 214 are completely matched and assembled with the front shell 211. Afterwards, the external force is removed, so that the quick-release sliding member 23 is transformed from the second position to the first position, the buckling blocks 233 pass through the lower through holes 213 to protrude from the shell member 21, thereby completing the assembly operation of the supporting device 1000 and the display 2000. To detach the supporting device 1000 from the display 2000, an external force is applied to the operating body 272, causing the quick-release sliding member 23 to transform from the first position to the second position, and the buckling blocks 233 to retract into the accommodation space 215, so that the main plate member 22, the quick-release sliding member 23, and the rear shell 214 pivot on the buckling tongue pieces 223, and that the buckling tongue pieces 223 are detached from the upper through holes 212.

In an embodiment, the front shell 211 can be assembled to the rear shell 214 without being fixed in the recess 2001 on the back surface 2004 of the display 2000, and when the supporting device 1000 is assembled to the display 2000, the carrying module 2 is entirely accommodated in the recess 2001 of the display 2000, and the buckling tongue pieces 223 and the buckling blocks 233 are buckled on the upper buckling grooves 2002 and the lower buckling grooves 2003, respectively, so that the supporting device 1000 of the present disclosure can be quick-releasably matched to the display 2000, but not limited thereto.

To sum up, the supporting device of the present disclosure uses the first positioning members and second positioning members to limit the stroke of the quick-release sliding member, and the through slots and the elastic members are misaligned with each other, such that the size of the quick-release sliding member can be reduced. In addition, the quick-release sliding member is sandwiched between the main plate member and the rear shell without being exposed, it is not prone to cause improper collision during assembly and it does not cause friction with the back shell of the display, and the front shell can be flatly attached to the recess on the back side of the display, so as to avoid tilting or improper shaking.

What is claimed is:

1. A supporting device for carrying a display on a work surface, the display including a back surface and a recess, the supporting device comprising:
a support unit disposed on the work surface; and
a carrying module pivotally connected to the support unit, and removably and matchingly accommodated on the back surface of the display, the carrying module including:
a shell member;
a main plate member disposed in the shell member and having at least two buckling tongue pieces and two bending pieces, wherein the buckling tongue pieces protrude from the shell member and are able to buckle on the display;
a quick-release sliding member disposed between the main plate member and the shell member and being able to transform between a first position and a second position relative to the main plate member, wherein the quick-release sliding member has at least two buckling blocks, two base portions and two through slots, the base portions are corresponding to the bending pieces and spaced apart from the bending pieces, and the through slots are respectively adjacent to the base portions and the bending pieces;
two elastic members, wherein two ends of each elastic member respectively abut against the bending pieces and the base portions, and wherein the elastic members and the through slots misaligned with each other;
two first positioning members respectively passing through the through slots and fixed to the main plate member; and
two second positioning members respectively passing through the through slots and fixed to the main plate member, and spaced apart from the first positioning members;
wherein when the quick-release sliding member is located at the second position, the elastic members are compressed, the second positioning members respectively abut against ends of the through slots, and the buckling blocks retract into the shell member, allowing the carrying module to be mounted in or detached from the display; wherein when the quick-release sliding member is located to the first position, the elastic members rebound, the first positioning members respectively abut against other ends of the through slots, and the buckling blocks protrude from the shell member, allowing the carrying module to be buckled on the display.

2. The supporting device of claim 1, wherein the quick-release sliding member further has a body and two wings, the wings respectively extend outward from opposite sides of the body, the buckling blocks extend outward from a bottom of the body and are spaced apart from each other, the base portions are formed on the body and spaced apart from each other and adjacent to the wings, and the through slots respectively formed through the wings.

3. The supporting device of claim 2, wherein the elastic members constantly provide an elastic force, the elastic force tends to maintain the quick-release sliding member at the first position.

4. The supporting device of claim 3, wherein the main plate member further has a plate body and two penetrating grooves, the buckling tongue pieces extend outward from the plate body, the penetrating grooves are spaced apart from each other and formed through the plate body, and the bending pieces extend outward from the plate body and correspond to the penetrating grooves respectively.

5. The supporting device of claim 4, wherein the quick-release sliding member further has two protrusions, the protrusions are spaced apart from each other and extend outward from the body and adjacent to the wings, and the protrusions are accommodated in the penetrating grooves respectively.

6. The supporting device of claim 5, wherein the elastic members are compression springs.

7. The supporting device of claim 6, wherein the first positioning members and the second positioning members are step screws.

8. The supporting device of claim 1, wherein the shell member has a front shell, at least two upper through holes and at least two lower through holes, the front shell is matchingly accommodated and flatly attached to the recess, the upper through holes are formed through the front shell for the buckling tongue pieces to pass through, and the lower through holes are formed through the front shell and are spaced from the upper through holes for the buckling blocks to pass through.

9. The supporting device of claim 8, wherein the shell member further has a rear shell and an accommodation space, the rear shell is assembled with the front shell to surround together and define the accommodation space, the main plate member and the quick-release sliding member are disposed in the accommodation space, and the upper through holes and the lower through holes communicate with the accommodation space.

10. The supporting device of claim 9, wherein the carrying module further includes an operating member having a base body and an operating body, the base body is fixed to the quick-release sliding member, the operating body extends outward from the base body, and the shell member further has an operating opening formed through the rear shell, and the operating body passes through the operating opening.
